(19) United States
(12) Patent Application Publication
(10) Pub. No.: US 2019/0234440 A1
(43) Pub. Date: Aug. 1, 2019

(54) METHOD AND ASSEMBLY FOR FASTENING A MULTIPLICITY OF COMPONENTS OF THE SAME TYPE

(71) Applicant: SIEMENS AKTIENGESELLSCHAFT, MUNCHEN (DE)

(72) Inventor: ROBERT EIDENBERGER, MÜNCHEN (DE)

(21) Appl. No.: 16/257,139

(22) Filed: Jan. 25, 2019

(30) Foreign Application Priority Data
Jan. 29, 2018 (EP) 18153876.0

(51) Int. Cl. F16B 4/00; G06N 3/08; G06N 20/00; F01D 5/32

(52) U.S. Cl. CPC F16B 4/004; G06N 3/08; B23P 19/02; F01D 5/32; G06N 20/00

(57) ABSTRACT

In order for a multiplicity of components of the same type to be fastened by bracing by means of dissimilar caulking pieces, a first component by an actuator is braced in a force-fitting manner in relation to a first caulking piece. A first bracing parameter herein is measured by a first sensor during the bracing procedure. A second caulking piece is then selected so as to depend on the first bracing parameter, a second component by the actuator being braced in a force-fitting manner in relation to said second caulking piece.

### CROSS-REFERENCE TO RELATED APPLICATION

This application claims priority to European application No. EP 18153876.0, having a filing date of Jan. 29, 2018, the entire contents of which are hereby incorporated by reference.

### FIELD OF TECHNOLOGY

The following relates to a method and to an assembly for fastening a multiplicity of components of the same type by way of force-fitting bracing by means of dissimilar caulking pieces.

### BACKGROUND

Fastening of components by means of caulking pieces is used in many production processes. One example thereof is inserting turbine blades into turbines. A multiplicity of turbine blades herein is typically manually hammered in each case over an appropriate caulking piece that is placed into a groove of the turbine so as to achieve a force-fitting bracing of the caulking piece, the turbine blades, and the groove. This herein is an interference fit, or a press fit, respectively, that is to say that the respective caulking piece is in each case somewhat thicker than the available gap.

By virtue of production inaccuracies of the turbine blades and of the receiving groove, caulking pieces of slightly dissimilar sizes are typically required for the turbine blades to be fastened in a secure manner. While a caulking piece that is too small typically does not permit any reliable fastening of the turbine blade, a caulking piece that is too large can hamper the bracing procedure or damage the turbine blade. In both cases, the turbine blade has to be hammered out again, a new caulking piece has to be selected, and the turbine blade has to be hammered by way of the new caulking piece. This is compounded in that any wrong dimensioning of a caulking piece is often recognized too late.

### SUMMARY

An aspect relates to a more efficient method as well as a more efficient assembly for fastening a multiplicity of components of the same type by means of dissimilar caulking pieces.

In order for a multiplicity of components of the same type to be fastened by bracing by means of dissimilar caulking pieces, according to embodiments of the invention a first component by an actuator is braced in a force-fitting manner in relation to a first caulking piece. A first bracing parameter is measured herein by a first sensor during the bracing procedure. A second caulking piece is then selected so as to depend on the first bracing parameter, a second component by the actuator being braced in a force-fitting manner in relation to said second caulking piece.

A force that arises and/or has to be applied when bracing, a pressure, a deformation, a displacement path, a spacing, and/or another physical parameter that is relevant to the bracing procedure can in particular be measured as a bracing parameter on the caulking piece and/or on the component.

An assembly for fastening a multiplicity of components of the same type, a computer program product (non-transitory computer readable storage medium having instructions, which when executed by a processor, perform actions), as well as a computer-readable storage medium are provided in order for the method according to embodiments of the invention to be carried out.

On account of embodiments of the invention, sensor data measured when fastening a first component can advantageously be utilized for selecting a caulking piece that is to be used for the next component. This advantage is based on the often prevailing situation that components of the same type are in most instances produced in batches and that production variations of successively produced components of one batch are in most instances minor and mutually correlated. In particular, production variations of one batch can often be readily extrapolated to the respective next component of said batch. This permits an automated and advantageous selection of caulking pieces and thus an efficient fastening of components of this type by way of only minor variations in terms of fastening quality.

Advantageous embodiments and refinements of the invention are stated in the dependent claims.

According to one advantageous embodiment of the invention, during the bracing procedure a temporal and/or path-dependent profile of the first bracing parameter can be measured and evaluated. The selection of the second caulking piece can then be performed so as to depend on the profile detected. A compressive force as a function of a displacement path of the first component and/or of the first caulking piece can in particular be measured as the profile of the first bracing parameter. By means of such a profile, an inappropriate caulking piece can already be identified at an early stage during the bracing procedure and optionally be replaced.

The first bracing parameter can furthermore be compared to one or a plurality of predefined nominal bracing parameters. The selection of the second caulking piece can then be performed so as to depend on the result of the comparison and in particular so as to depend on a deviation between the first bracing parameter and a nominal bracing parameter. A temporal and/or path-dependent profile of the first bracing parameter can be compared continuously to a predefined nominal profile. A tolerance range can in particular also be predefined for the predefined nominal bracing parameter or the predefined nominal profile, and said tolerance range can be compared to the first bracing parameter.

According to one advantageous embodiment of the invention a variation trend for the bracing parameter can be determined from the first bracing parameter and one or a plurality of bracing parameters measured earlier. The selection of the second caulking piece can then be performed so as to depend on the variation trend. The variation trend can be determined, for example, by subtraction or by linear or non-linear regression. A bracing parameter for the second component can be extrapolated by means of the variation trend. The extrapolated bracing parameter can then be compared to the nominal bracing parameter and optionally the tolerance range of the latter. An extrapolation of this type in many cases leads to the selection of a more suitable caulking piece for the second component.

It can furthermore be verified whether the variation trend meets a predefined inconsistency criterion. In the affirmative, the selection of the second caulking piece can be modified. In order for an inconsistency of this type to be identified, successive variations of the bracing parameter and/or a deviation of a measured bracing parameter from the extrapolated bracing parameter can be assessed, for example. An inconsistency of this type can be considered to be an indicator for a batch change or another change in the production process for the components. In such cases it is often advantageous for the selection method to be changed or to be otherwise modified.

According to one further advantageous design embodiment of the invention a fastening parameter of the first component can be measured by a second sensor. The selection of the second caulking piece can then be performed so as to depend on the fastening parameter. A spacing, a position, an orientation, a gap width, or a form-fit in relation to previously fastened components can in particular be measured as the fastening parameter. Alternatively or additionally, the fastening parameter can relate to a fixing, a clearance, mobility, a deformation, and/or a mechanical stress of the first component. The fastening parameter can quantify a fastening quality. The fastening quality herein can, for example, relate to a fixing, a deviation from the nominal, and/or a reliability of the fastening.

According to one advantageous refinement of the invention a machine-based learning routine for the dissimilar caulking pieces can be taught by means of a multiplicity of measured bracing parameters and fastening parameters with a view to determining bracing parameters which optimize a fastening quality. The first bracing parameter can then be compared to the bracing parameter that optimizes the fastening quality for the first caulking piece, and the selection of the second caulking piece can be performed so as to depend on the result of the comparison. Machine-based learning routines by means of standard methods of machine-based learning can be efficiently taught with a view to identifying and representing also non-linear influences on the fastening quality. In this way, a prognosis pertaining to a suitable caulking piece size and thus to a fastening quality can be typically improved in a significant manner.

The actuator can furthermore be actuated in such a manner that the bracing procedure of the second component is varied in relation to the bracing procedure of the first component so as to depend on the first bracing parameter.

It can moreover be verified whether the first bracing parameter, the fastening parameter, or the respective profile of the two former lies in a predefined tolerance range. As a result of a negative verification result the first caulking piece can be removed by means of the actuator and a second caulking piece can be selected so as to depend on the first bracing parameter. The first component by means of the actuator can then be braced in a force-fitting manner in relation to the selected second caulking piece. In order for the first caulking piece to be removed, the actuator can be designed so as to apply force on both sides onto the first caulking piece and/or the first component.

### BRIEF DESCRIPTION

Some of the embodiments will be described in detail, with references to the following Figures, wherein like designations denote like members, wherein:

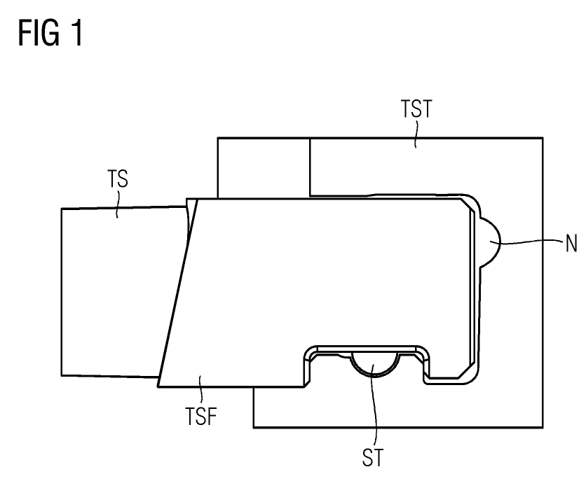

FIG. 1 shows a turbine blade fastened by means of a caulking piece in a turbine blade carrier;

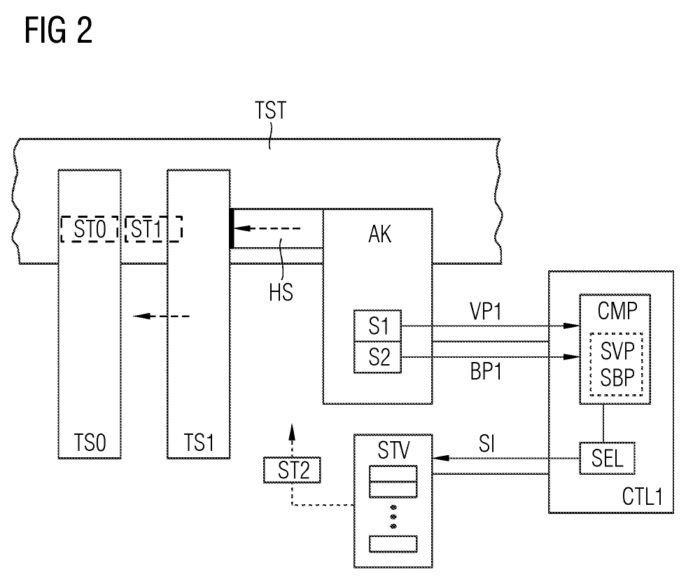

FIG. 2 shows an assembly for fastening turbine blades, according to a first exemplary embodiment of the invention; and

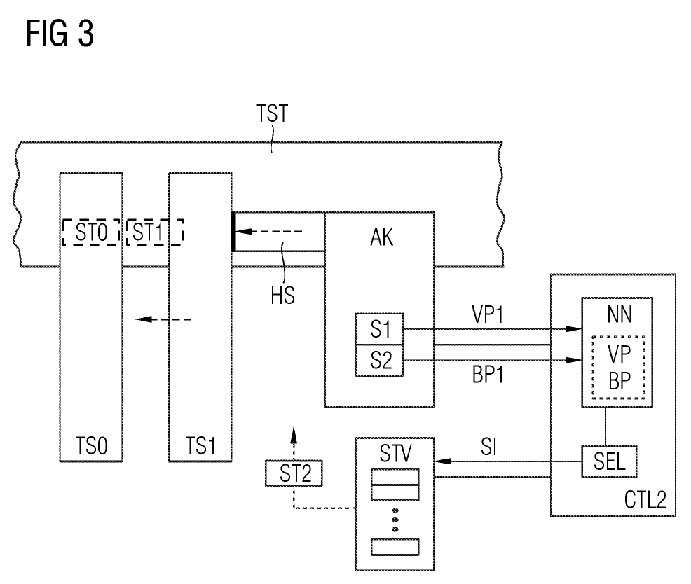

FIG. 3 shows an assembly for fastening turbine blades, according to a second exemplary embodiment of the invention.

### DETAILED DESCRIPTION

Fastening turbine blades to a blade carrier of a steam turbine is described hereunder as an exemplary embodiment of fastening a multiplicity of components of the same type by caulking pieces according to embodiments of the invention. A multiplicity of turbine blades of the same type herein are inserted in a groove on the internal side of an annular turbine blade carrier, and by means of caulking pieces are braced in a force-fitting manner therein. To this end, caulking pieces of slightly dissimilar sizes are provided for equalizing inevitable production tolerances in the turbine blades. The selection of a respective suitable caulking piece and thus the fastening procedure are in particular improved on account of embodiments of the invention.

FIG. 1 in a schematic illustration shows a turbine blade TS that by means of a caulking piece ST has been fastened in a turbine blade carrier TST. The caulking piece ST serves for the force-fitting bracing in relation to a turbine blade root TSF of the turbine blade TS within the turbine blade carrier TST. For this purpose, the caulking piece ST is inserted into a groove provided therefor of the turbine blade carrier TST. After the insertion of the caulking piece ST, the turbine blade TS by way of the turbine blade root TSF thereof is introduced into the turbine blade carrier TST and is slid and/or hammered over the caulking piece ST such that the turbine blade root TSF and the caulking piece ST are pressed onto one another in a force-fitting manner. The size of the caulking piece ST herein is to be chosen such that the turbine blade root TSF is fixed securely and without clearance in the turbine blade carrier TST. A further groove N serves for a further caulking piece (not illustrated) to be subsequently slid in or hammered in.

FIG. 2 in a schematic illustration shows an assembly for fastening turbine blades in a turbine blade carrier TST, according to a first exemplary embodiment of the invention. A respective turbine blade root of the turbine blades as well as a groove for the caulking pieces are not separately illustrated for reasons of clarity.

As a first component to be fastened, a turbine blade TS1 of a multiplicity of turbine blades of the same type for bracing is to be slid over a first caulking piece ST1. The first caulking piece ST1 herein is selected from a multiplicity of caulking pieces of slightly dissimilar sizes of a caulking piece supply STV. The first caulking piece ST1 is inserted in a groove provided therefor of the turbine blade carrier TST and serves for bracing the blade root of the turbine blade TS1 in a force-fitting manner in the turbine blade carrier TST. The turbine blade TS1 is to be slid so far beyond the first caulking piece ST1 until said turbine blade TS1 adjoins a turbine blade TS0 that by means of a caulking piece ST0 has already been previously fastened in the turbine blade carrier TST.

The assembly according to embodiments of the invention possesses a control installation CTL1 for controlling the fastening method. The control installation CTL1 comprises one or a plurality of processors for carrying out the method steps of the control installation CTL1, as well as one or a plurality of memories and/or a database for storing data to be processed by the control installation CTL1.

The control installation CTL1 is linked to the caulking piece supply STV and to a hydraulic actuator AK. The control installation CTL1 controls in particular a selection of an appropriate caulking piece from the caulking piece supply STV, and a respective bracing procedure of a respective turbine blade in relation to a respective caulking piece.

The hydraulic actuator AK with the aid of a hydraulic die HS slides a turbine blade to be fastened, presently TS1, in the turbine blade carrier TST over a caulking piece, presently ST1, that is placed into the groove of said turbine blade carrier TST, and on account thereof braces the turbine blade TS1 in a force-fitting manner in relation to the caulking piece ST1. The actuator AK can displace the turbine blade TS1 by a continuous application of force and/or by way of hammer blows specifically so far until said turbine blade TS1 adjoins a previously fastened turbine blade, presently TS0. Alternatively or additionally, a pneumatic and/or magnetic actuator can be used as the actuator AK.

A robot (not illustrated) or another manipulator can be provided for conveying a respective caulking piece from the caulking piece supply STV into the groove provided therefor of the turbine blade carrier TST, for introducing a respective turbine blade into the turbine blade carrier TST, as well as for tracking the actuator AK.

During the bracing procedure of the turbine blade TS1 a first sensor S1 measures a first bracing parameter VP1. A force, a pressure, a displacement path, a displacement time that arises and/or is to be applied in the bracing procedure, or another physical parameter that is relevant to the bracing procedure can be measured as the first bracing parameter VP1, for example. Accordingly, the first sensor S1 can be designed as a force sensor, pressure sensor, position sensor, or another bracing sensor. The first sensor S1 is integrated in the actuator AK.

In particular, a compressive force that is applied by the actuator AK as a function of a displacement path of the turbine blade TS1, that is to say a force/path profile, can be measured as the first bracing parameter VP1 by the first sensor S1.

The first bracing parameter VP1, or the profile thereof, respectively, is transmitted to the control installation CTL1 for evaluation. The bracing parameter VP1, or the profile thereof, respectively, in a comparison module CMP of the control installation CTL1 is compared to a predefined nominal bracing parameter SVP, or to a corresponding nominal profile, respectively.

The nominal bracing parameter SVP can, for example, indicate a desired force, a pressure, a displacement path, a displacement time, or another physical parameter that is relevant to the bracing procedure, in each case for dissimilar blade-groove combinations and dissimilar materials. Additionally, a tolerance range is advantageously predefined for the nominal bracing parameter SVP. In particular, the nominal bracing parameter SVP can predefine a compressive force that is to be applied by the actuator AK as a function of the displacement path, that is to say a nominal force/path profile. The profile of the first bracing parameter VP1 can then be continuously compared to the profile of the nominal bracing parameter SVP and optionally to the tolerance range thereof, or the profile thereof, respectively. In particular, a quality of fastening can be determined herein from a deviation of the first bracing parameter VP1 from the nominal bracing parameter SVP.

Alternatively or additionally to a direct comparison between the first bracing parameter VP1 and the nominal bracing parameter SVP, the first bracing parameter VP1 can be extrapolated by means of bracing parameters which were measured in the bracing of previously fastened components, presently TS0, and the result of the extrapolation can be compared to the nominal bracing parameter SVP, or the associated tolerance range, respectively. For this purpose, a variation trend, for example by linear or non-linear regression, can be determined by means of the previously measured bracing parameters. The bracing parameter to be expected in the case of the next turbine blade to be fastened is extrapolated by means of the variation trend determined. The use of an extrapolated value for the bracing parameters often delivers better results than any direct use of the last measured bracing parameter, presently VP1. This can be traced back to turbine blades typically being produced successively in batches. Production variations in the case of successively produced turbine blades are typically minor and most often vary in a uniform or consistent manner, for example because a tool wears consistently over the course of time.

It is advantageously verified whether the determined variation trend meets an inconsistency criterion. In order for such an inconsistency to be identified, a deviation of the measured bracing parameter VP1 from the extrapolated value can be compared to a threshold value, for example. An inconsistency can then be flagged when the threshold value is exceeded. An inconsistency of this type can be assessed as an indicator for a batch change or another change in the production process of the turbine blades.

A fastening parameter BP1 of the turbine blade TS1 is measured by a second sensor S2 in order for the fastening of the turbine blade TS1 to be assessed. The fastening parameter BP1 can, for example, indicate a spacing, a position, an orientation, a gap width, or a form-fit, in particular in relation to previously fastened components or other parts of the turbine blade carrier TST or of the turbine. Alternatively or additionally, the fastening parameter B1 can relate to a fixing, a clearance, mobility, a deformation, and/or a mechanical stress. The second sensor S2 can be designed as an active sensor which applies a force to the turbine blades TS1 and/or the caulking piece ST1 and herein measures a deformation and/or mobility of the braced component. The second sensor S2 can in particular be integrated in the actuator AK.

In the present exemplary embodiment, a bracing, for example a force, a contact pressure, and/or a deformation of the fastened turbine blade TS1 and/or of the caulking piece ST1 is measured as the fastening parameter BP1 by the second sensor S2. To this end, the second sensor S2 accesses measured values of the first sensor S1 or is partially or entirely identical to the latter.

A fastening parameter that is to be expected in the next component can be extrapolated by means of the fastening parameter BP1 and previously measured fastening parameters.

The fastening parameter BP1 is transmitted to the control installation CTL1 for evaluation. The control installation CTL1 by means of the fastening parameter BP1 determines in particular a fastening quality of the currently fastened turbine blade TS1. The fastening quality herein can in particular relate to or quantify a fixing, a deviation from the nominal, and/or a reliability of the fastening.

The fastening parameter BP1 is compared to a predefined nominal fastening parameter SBP in the comparison module CMP of the control installation CTL1. The nominal fastening parameter SBP is predefined in each case for dissimilar blade/groove combinations and dissimilar materials. Alternatively or additionally, a respective tolerance range for a respective nominal fastening parameter SBP can be predefined.

A selection module SEL that is linked to the comparison module CMP is actuated by the latter so as to depend on a deviation between the first bracing parameter VP1 or the extrapolated bracing parameter and the nominal bracing parameter SVP, or between the respective profiles thereof. A deviation between the fastening parameter BP1 or the extrapolated fastening parameter and the nominal fastening parameter SBP can also be considered herein.

The selection module SEL is part of the control installation CTL1 and serves for selecting an appropriate caulking piece for bracing the respective next component to be fastened, presently the turbine blades (not illustrated) that is to be fastened after the turbine blade TS1. To this end, a second caulking piece ST2 is selected by the selection module SEL in the present exemplary embodiment. The selection herein can also be performed in such a manner that in the case of a bracing parameter VP1 that is increased in relation to the nominal bracing parameter SVP a caulking piece, presently ST2, which is smaller in relation to the current caulking piece, presently ST1, is selected, and in the case of a lower bracing a larger caulking piece is accordingly selected.

The selection can moreover be modified when an inconsistency in the trend of the bracing parameters or fastening parameters is established. In this case, an extrapolation can thus be suppressed, a selection parameter can thus be varied, and/or a selection method can thus be changed.

In the context of the selection of the caulking piece, an item of selection information SI is generated by the selection module SEL, said item of a selection information SI indicating the respective selected caulking piece, presently ST2, and in particular the size thereof. This item of selection information SI is transmitted from the selection module SEL to the caulking piece supply STV and initiates the latter to provide the caulking piece, presently ST2, that is identified by the item of selection information SI. The selected caulking piece ST2 is subsequently used for fastening the next turbine blade (not illustrated).

The bracing procedure per se when bracing the next component can also be varied so as to depend on the first bracing parameter VP1 and/or the fastening parameter BP1. For example, when the first bracing parameter VP1 indicates an increased effort in force, a displacement speed of the actuator AK in the bracing of the next turbine blade can thus be reduced.

It is more over verified whether the first bracing parameter VP1 and/or the fastening parameter BP1 lie/lies outside a respective tolerance range of the nominal bracing parameter, or nominal fastening parameter, respectively. In the affirmative, the first caulking piece ST1 by means of the actuator is removed again and instead a new caulking piece is selected, inserted, and braced. For this purpose, the actuator AK can be designed for applying force on both sides to, or for hammering on both sides of, respectively, the respective turbine blade and/or the respective caulking piece.

FIG. 3 in a schematic illustration shows an assembly for fastening turbine blades in a turbine blade carrier TST, according to a second exemplary embodiment of the invention.

In as far as the same reference signs are used in FIG. 3 as in FIG. 2, said reference signs refer to the same entities. Said entities can be implemented or realized as described in the functional context of FIG. 3 as well as in the context of FIG. 2.

The second exemplary embodiment differs from the first exemplary embodiment by way of a dissimilarly implemented second control installation CTL2. Like the first control installation CTL1, the second control installation CTL2 serves for controlling the fastening method. Said control installation CTL2 comprises one or a plurality of processors for carrying out the method steps of the control installation CTL2, as well as one or a plurality of memories and/or a database for storing items of data that are to be processed by the control installation CTL2. In particular, the second control installation CTL2 can be used instead of the control installation CTL1 in the first exemplary embodiment visualized by FIG. 2.

The second control installation CTL2 moreover comprises an artificial neural network NN as well as a selection module SEL linked thereto. The selection module SEL, like the selection module of the control installation CTL1, serves for selecting an appropriate caulking piece, presently ST2, for bracing the respective next component to be fastened, presently the next turbine blade (not illustrated).

The selection is performed by means of the first bracing parameter VP1 that has been measured by the first sensor S1, as well as by means of the fastening parameter BP1 that has been measured by the second sensor S2, said parameters for this purpose being transmitted to the neural network NN and being evaluated by the latter.

A machine-based learning routine is implemented by means of the neural network NN. The neural network NN by means of a multiplicity of measured bracing parameters VP and BP is trained for the dissimilar caulking pieces of the caulking piece supply STV. The training is in each case performed for dissimilar blade-groove combinations as well as for dissimilar materials. A multiplicity of standard methods of machine-based learning known to a person skilled in the art can be accessed for training the neural network NN. The items of training data VP and BP used for training the neural network NN are indicated by a dotted rectangle in FIG. 3.

The neural network NN by means of the bracing parameters VP and the fastening parameters BP is trained with a view of determining those bracing parameters which optimize a fastening quality. The fastening quality herein can be defined as has been described above. The neural network NN is continually further trained by way of respective currently measured bracing parameters and fastening parameters, presently VP1 and BP1.

The determined optimized bracing parameter in the second exemplary embodiment has a function that is analogous to that of the nominal bracing parameters SVP in the first exemplary embodiment. Accordingly, the selection of the next caulking piece to be used can be performed in such a manner that in the case of a bracing VP1 that is increased in relation to the optimized bracing parameter a caulking piece, presently ST2, that is smaller in relation to the current caulking piece ST1 is selected, and in the case of a lower bracing a larger caulking piece is accordingly selected.

An item of selection information SI which indicates the respective selected caulking piece, presently ST2, and in particular the size thereof, is generated by the selection module SEL, as in the first exemplary embodiment, in order for the caulking piece to be selected. The item of selection information SI is transmitted from the selection module SEL to the caulking piece supply STV and the initiates the latter to provide the caulking piece ST2 that has been identified by the item of selection information SI.

The selection method by means of the neural network NN according to the second exemplary embodiment can also be combined with the selection method according to the first exemplary embodiment. In particular, besides the optimized bracing parameters determined by the neural network NN, nominal bracing parameters or nominal fastening parameters can also be considered in the selection.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A method for fastening a multiplicity of components of a same type by bracing by means of dissimilar caulking pieces, the method comprising:
a) bracing a first component by an actuator in a force-fitting manner in relation to a first caulking piece, wherein a first bracing parameter is measured by a first sensor during the bracing procedure;
b) selecting a second caulking piece so as to depend on the first bracing parameter; and
c) bracing a second component by the actuator in a force-fitting manner in relation to the selected second caulking piece.

2. The method as claimed in claim 1, wherein during the bracing procedure a temporal and/or path-dependent profile of the first bracing parameter is measured and evaluated, and in that a selection of the second caulking piece is performed so as to depend on the profile detected.

3. The method as claimed in claim 1, wherein the first bracing parameter is compared to one or a plurality of predefined nominal bracing parameters; and in that a selection of the second caulking piece is performed so as to depend on a result of the comparison.

4. The method as claimed in claim 1, wherein a variation trend for the bracing parameter is determined from the first bracing parameter and one or a plurality of bracing parameters; and in that the selection of the second caulking piece is performed so as to depend on the variation trend.

5. The method as claimed in claim 4, further comprising verifying it is whether the variation trend meets a predefined inconsistency criterion and, in the affirmative, the selection of the second caulking piece is modified.

6. The method as claimed in claim 1, wherein a fastening parameter of the first component is measured by a second sensor, and in that a selection of the second caulking piece is performed so as to depend on the fastening parameter.

7. The method as claimed in claim 6, wherein a machine-based learning routine for the dissimilar caulking pieces is taught by means of a multiplicity of measured bracing parameters and fastening parameters with a view to determining bracing parameters which optimize a fastening quality; in that the first bracing parameter is compared to the bracing parameter that optimizes the fastening quality for the first caulking piece; and in that the selection of the second caulking piece is performed so as to depend on the result of the comparison.

8. The method as claimed in claim 1, wherein the actuator is actuated in such a manner that the bracing of the second component is varied in relation to the bracing of the first component so as to depend on the first bracing parameter.

9. The method as claimed in further comprising verifying whether the first bracing parameter lies in a predefined tolerance range;
in that as a result of a negative verification result the first caulking piece is removed by means of the actuator; in that a second caulking piece is selected so as to be depend on the first bracing parameter; and in that the first component by the actuator is braced in a force-fitting manner in relation to the selected second caulking piece.

10. The method as claimed in claim 1, wherein the actuator comprises the first sensor and/or the second sensor.

11. The method as claimed in claim 1, wherein the bracing is performed by hammer blows and/or a continuous application of force by the actuator.

12. An assembly for fastening a multiplicity of components of the same type, specified for carrying out a method as claimed in claim 1.

13. A computer program product, comprising a computer readable hardware storage device having computer readable program code stored therein, said program code executable by a processor of a computer system to implement a method specified for executing a method as claimed in claim 1.

14. A computer-readable storage medium having a computer program product as claimed in claim 13.
